(19) United States
(12) Patent Application Publication
(10) Pub. No.: US 2003/0195751 A1
(43) Pub. Date: Oct. 16, 2003

(54) Distributed automatic speech recognition with persistent user parameters

(75) Inventors: Derek L. Schwenke, Marlborough, MA (US); David W. H. Wong, Boxborough, MA (US)

Correspondence Address: Patent Department, Mitsubishi Electric Research Laboratories, Inc., 201 Broadway, Cambridge, MA, 02139, US

(73) Assignee: Mitsubishi Electric Research Laboratories, Inc.

(21) Appl. No.: 10/119,880

(22) Filed: Apr. 10, 2002

(51) Int. Cl. G10L 21/00

(52) U.S. Cl. 704/270.1

(57) ABSTRACT

A method for distributed automatic speech recognition enables a user to request an audio web page from a speech server by using a browser of a speech client connected to the speech server via a communications network. A determination is then made whether persistent user parameters are stored for the user in a parameter file on the speech client accessible by the speech server. If false, the user parameters are generated in the speech client, and stored in the parameter file. If true, the user parameters are directly read from the parameter file by the speech server. In either case, the user parameters are set in a speech recognition engine of the speech server to perform an audio dialog between the speech client and the speech server.

### FIELD OF THE INVENTION

This invention relates generally to automatic speech recognition, and more particularly to distributed speech recognition using web browsers.

### BACKGROUND OF THE INVENTION

Automatic speech recognition (ASR) receives an input acoustic signal from a microphone, and converts the acoustic signal to an output set of text words. The recognized words can then be used in a variety of applications such as data entry, order entry, and command and control.

Text to speech (TTS) converts text input to an output acoustic signal that can be recognized as speech.

The Internet and the World-Wide-Web (the “web”) provide a wide range of information in the form of web pages stored in web or proxy servers. The information can be accessed by client browsers executing on desktop computers, portable computers, handheld personal digital assistants (PDAs), cellular telephones, and the like. The information can be requested via input devices such as a keyboard, mouse, or touch pad, and viewed on an output device such as a display screen or printer.

Audio web pages provide information for client devices with limited input and output capabilities. Audio web pages are available from web servers. A number of standards are known for the description of audio web pages. These include Sun's Java Speech, Microsoft's Speech Agent and Speech.NET, the SALT Forum, VoiceXML Forum, and W3C VoiceXML. These pages contain voice dialogs and may also contain regular HTML text content.

Distributed automatic speech recognition (DASR) enables client devices with limited resources, such as memories, displays, and processors, to perform ASR. These resource-limited devices can be supported by the ASR executing remotely. DASR can execute on a web server or in a proxy server located in the network connecting the client's browser and the web server.

Multimedia content of web pages can include text, images, video, and audio. More recently developed web pages can even contain instructions to an ASR/TTS to provide an audio user interface, instead of or in addition to the traditional graphical user interface (GUI).

Audio Forms serve a similar function as web forms on text pages. Web forms are the standard way for a web application to receive user input. Audio forms provide any number of Fields. Each Field has a Prompt and Reply. Each Prompt is played and the Reply is “filled” by speech or a time out can occur if no speech is detected.

Voice applications often use both TTS and ASR software and hardware. Much progress has been made in ASR and TTS but errors still occur. Errors in the TTS can produce the wrong sound, timing, tone, or accent, and sometimes just the wrong word. Those errors often sound wrong but users can learn to correct and compensate for those types of errors. On the other hand, errors in ASR often require a second attempt to correct the error. This makes it difficult to use ASR. ASR errors are often misrecognized words that are phonetically close to the correct word, or cases where background noise masks the spoken words. Any technique that reduces such errors constitutes an improvement in the performance of ASR.

Error reduction techniques are well known. One such technique provides the ASR with a grammar or a description language that specify the set of acceptable words or phrases to be recognized. The ASR uses the grammar to determined whether the results match any possible expected result during speech to text conversion. If no match is found, then an error can be signaled. But even when grammars are used, the ASR can still make errors that conform to the grammar.

Fewer errors occur when the ASR is trained with the speech of a particular user. Training measures parameters of speech that make it unique. The parameters can consider pitch, rate, dialects, and the like. Typically, training is performed by the user speaking words that are known to the ASR, or by the ASR extracting the parameters over multiple training sessions. Characteristics of the speech acquisition hardware, such as microphone and amplifier settings can also be learned. However, for some applications where many users access the ASR, training is not possible. For example, the number of users that can call into an automated telephone call center is very large, and there is no way that the ASR can determine which user will call next, and what parameters to use.

When the application is built to accept any speech, it is much harder to filter out noise. This leads to recognition errors. For example, background speech can confuse the ASR.

Prior art solutions for this problem restrict the users input to a limited set of words, e.g., the ten digits 0-10 and “yes” and “no,” so that the ASR can ignore words that are not part of its vocabulary to minimize errors.

Thus, the prior art solutions typically take the following approaches. The ASR only recognizes a limited set of words for a large number of users. The system is trained for each user. The system is trained for each session. The user provides an identification while a default speech recognition model is used. The ASR dynamically determines expected recognition parameters from training speech at the beginning of a session. In this type of solution, the initial parameters can be wrong until they are adjusted. This causes errors and wastes time.

The recognition problem is more difficult for DASR servers because the DASR is accessed by many users who may access a site in random orders and at random times. Having to train the server for each user is a time consuming and tedious process. Moreover, users may not want to establish accounts with each site for privacy reasons. Cookies do not solve this problem either because cookies are not shared between sites. A new cookie is needed for each site accessed.

FIG. 1 shows a prior art DASR 100. The DASR 100 includes a speech client 101 connected to a speech server 102 via a communications network 103, e.g., the Internet. The speech client 101 includes acquisition settings 110 that characterize the hardware used to acquire the speech signal, and a user parameter file 111. The speech server 102 includes a web server 120, and an ASR 121. Note, the web server has no direct access to the parameter file.

For additional background on speech recognition systems, see, e.g. U.S. Pat. No. 6,356,868, “Voiceprint identification system,” Yuschik et al., Mar. 12, 2002, U.S. Pat. No. 6,343,267, “Dimensionality reduction for speaker normalization and speaker and environment adaptation using eigenvoice techniques,” Kuhn et al, Jan. 29, 2002, U.S. Pat. No. 6,347,296, “Correcting speech recognition without first presenting alternatives,” Friedman, Feb. 12, 2002, U.S. Pat. No. 6,347,280, “Navigation system and a memory medium in which programs are stored,” Inoue, et al., Feb. 12, 2002, U.S. Pat. No. 6,345,254, “Method and apparatus for improving speech command recognition accuracy using event-based constraints,” Lewis, et al., Feb. 5, 2002, U.S. Pat. No. 6,345,253, “Method and apparatus for retrieving audio information using primary and supplemental indexes,” Viswanathan, Feb. 5, 2002 and U.S. Pat. No. 6,345,249, “Automatic analysis of a speech dictated document,” Ortega, et al, Feb. 5, 2002.

### SUMMARY OF THE INVENTION

A method for distributed automatic speech recognition according to the invention enables a user to request an audio web page from a speech server by using a browser of a speech client connected to the speech server via a communications network.

A determination is then made whether persistent user parameters are stored for the user in a parameter file on the speech client accessible by the speech server. If false, the user parameters are generated in the speech client, and stored in the parameter file. If true, the user parameters are directly read from the parameter file by the speech server.

In either case, the user parameters are set in a speech recognition engine of the speech server to perform an audio dialog between the speech client and the speech server.

### BRIEF DESCRIPTION OF THE DRAWINGS

FIG. 1 is a block diagram of a prior art distributed automatic speech recognition (DSR) system;

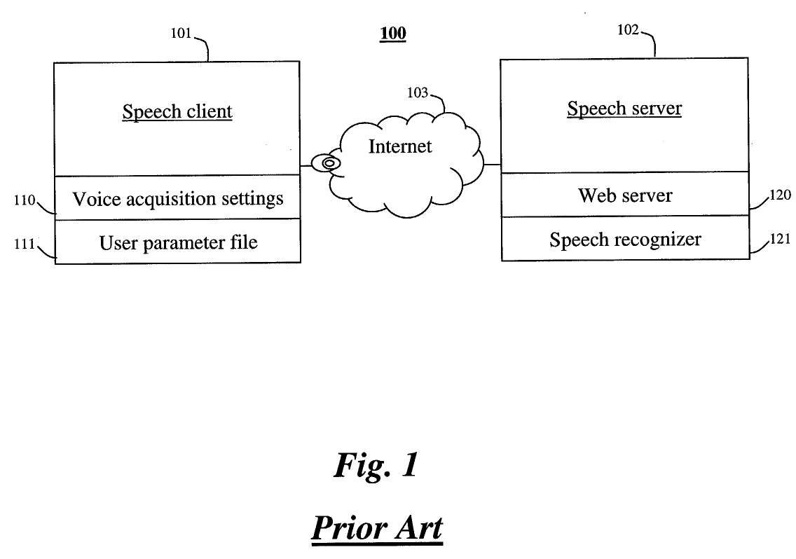

FIG. 2 is a process flow diagram of a DASR system according to the invention; and

FIG. 3 is a data flow diagram of the DASR system according to the invention.

### DETAILED DESCRIPTION OF THE PREFERRED EMBODIMENT

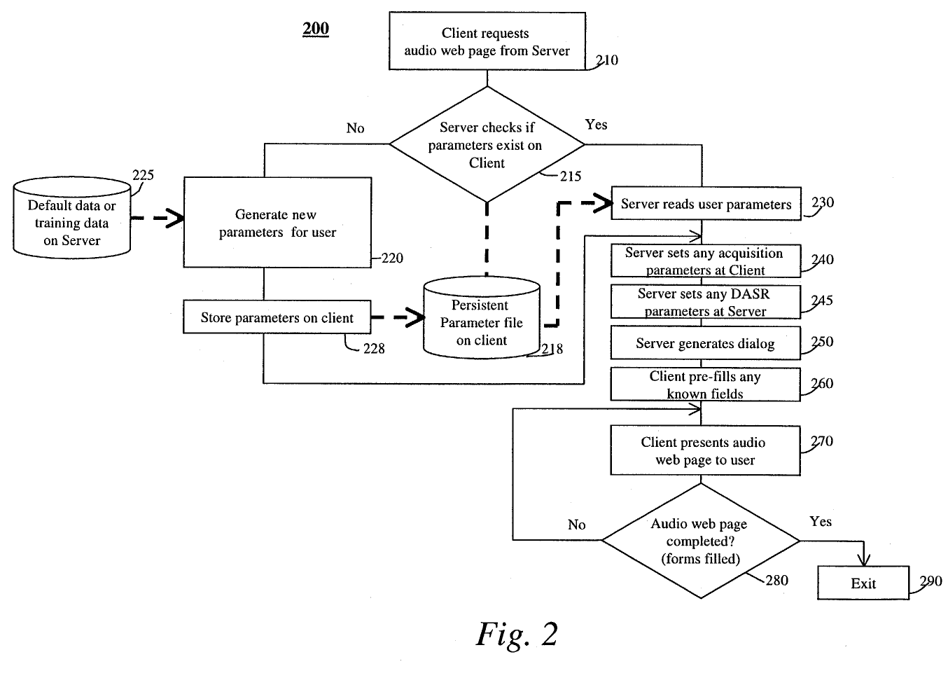

FIG. 2 shows a distributed automatic speech recognition (DASR) system and method 200 according to the invention. The system maintains persistent user parameters on a speech client that can be accessed by a speech server during speech recognition. The user parameters model the users' voice and can also include settings of hardware used to acquire speech signals. In addition the parameters can include information to pre fill forms in audio web pages. For example, demographic data such as name and address of particular users, or other default values or preferences of users, or system identification information.

The method according to the invention includes the following steps. A user of a speech client requests an audio web page 210 from a speech server that is enabled for DASR. The request can be made with any standard browser application program. After the request is made, the server determines 215 if the user parameters are stored on a persistent storage device, e.g., a disk, or non-volatile memory 218 on the client. As an advantage, the parameter file is directly accessible by the speech server.

If the user parameters are not stored, i.e., the determination returns a false condition, then new user parameters are generated 220 either by using default or training data 225. The generated parameters are then stored 228 in the parameter file 218. Multiple sets of user parameters can be stored for a particular user. For example, different web servers may use different implementations of a speech recognition engines that require different parameters, or the user can have different preferences depending on the web server or site accessed. The user parameters can be stored 218 in any format on a local file of the speech client.

If the user parameters are stored, i.e., the determination returns a true condition, then the user parameters are read 230 from the parameter file 218. The audio acquisition parameters 240 are set in the speech client for the user. The DASR user parameters are set in the speech server 245. The appropriate dialog is generated 250 to communicate with the user. The user parameters can also be used to pre fill forms 260 of audio web pages. The dialog is then presented to the user 270, and a check is made 280 to see if any required forms are complete. If not, then the dialog is further processed 270, otherwise exit 290.

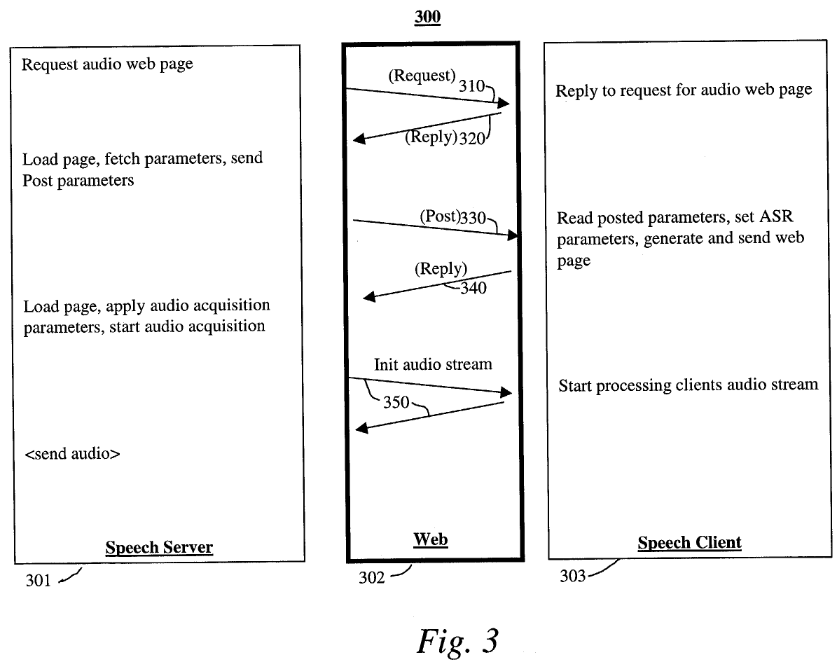

FIG. 3 shows the data flow 300 of the DASR system and method according to the invention. A speech client 303 is connected to a speech server 301 by the web 302. The speech client 303 makes a request to get 310 an audio web page from the speech server 301. In reply, the speech server provides the audio web page to the speech client. The speech client loads the audio web page, fetches necessary parameters, and posts 330 the user parameters to the speech server. The speech server reads the posted parameters, sets the ASR parameters, and generates and sends the 340 audio web page to the client. The speech client loads the audio web page, applies the audio acquisition parameters, and start audio acquisition to engage 350 in a speech dialog with the speech server. As an advantage, the DASR according to the invention saves time, and has fewer errors than prior art DASR systems.

Although the invention has been described by way of examples of preferred embodiments, it is understood that various other adaptations and modifications can be made within the spirit and scope of the invention. Therefore, it is the object of the appended claims to cover all such variations and modifications as come within the true spirit and scope of the invention.

I claim:

1. A method for distributed automatic speech recognition, comprising:
requesting an audio web page by a speech client from a speech server by a user via a communications network;
determining whether user parameters are stored for a user in a parameter file directly accessible by the speech server;
if false, generating the user parameters in the speech client, and storing the user parameters in the parameter file;
if true, directly reading the user parameters from the parameter file by the speech server;
setting the user parameters in a speech recognition engine of the speech server to perform an audio dialog between the speech client and the speech server.

2. The method of claim 1 further comprising:
maintaining the parameter file by the speech server.

3. The method of claim 1 further comprising:
maintaining the parameter file by a speech proxy server.

4. The method of claim 1 wherein the user parameters include speech parameters characterizing speech of the user.

5. The method of claim 1 wherein the user parameters include acquisition parameters characterizing hardware used to acquire speech from the user, and further comprising:
setting the acquisition parameters in the speech client.

6. The method of claim 1 wherein the user parameters include user identification information.

7. The method of claim 1 further comprising:
encoding the user parameters as a cookie.

8. The method of claim 1 wherein the user parameters are generated by default.

9. The method of claim 1 wherein the user parameters are generated by training.

10. The method of claim 1 wherein multiple sets of user parameters are maintained for the user.

11. A distributed automatic speech recognition system, comprising:
a speech client requesting an audio web page;
a speech server receiving the request for the audio web page via a communications network;
a parameter file directly accessible by the speech server;
means for determining whether user parameters are stored for a user in the parameter file;
means for generating the user parameters in the speech client, and storing the user parameters in the parameter file, if false;
means for directly reading the user parameters from the parameter file if true;
means for setting the user parameters in a speech recognition engine of the speech server to perform an audio dialog between the speech client and the speech server.
